(19) United States
(12) Patent Application Publication
(10) Pub. No.: US 2022/0108376 A1
(43) Pub. Date: Apr. 7, 2022

(54) SYSTEM AND METHOD FOR AUTOMATED GIFTING

(71) Applicant: Ray D. Bean, San Diego, CA (US)

(72) Inventor: Ray D. Bean, San Diego, CA (US)

(21) Appl. No.: 17/494,302

(22) Filed: Oct. 5, 2021

Related U.S. Application Data
(60) Provisional application No. 63/087,359, filed on Oct. 5, 2020.

(51) Int. Cl. G06Q 30/06

(52) U.S. Cl. CPC G06Q 30/0631

(57) ABSTRACT

Embodiments of a device including a memory including processor readable instructions for controlling the device and a processor are disclosed. The at least one processor is configured to execute the processor readable instructions to control the device to: obtain user contact information, wherein the user contact information is information relating via a communication method associated with a contact of a user, wherein the user contact information includes information allowing the device to contact the contact of the user; send contact interest request to the contact of the user using the information allowing the device to contact the contact of the user; obtain contact interest information, wherein the contact interest information is a response to the contact interest request; determine suggested gifts for the contact of the user based on the contact interest information; and send a suggested gift list including indications of the suggested gifts to the user.

### CROSS REFERENCE TO RELATED APPLICATIONS

This application claims priority to Provisional Patent No. 63/087,359, which was filed Oct. 5, 2020, which is incorporated in its entirety.

### FIELD OF THE DISCLOSURE

The present invention relates to devices, applications, and methods for automated gift suggestion and gift giving.

### BACKGROUND

Gift giving has been a part of human life for millennia. However, many struggle with finding meaningful gifts to give to loved ones and friends. Various forms of help for people who struggle with gift giving exist, such as getting advice from other acquaintances of the friend or loved one, or looking at lists of most popular items. However, this process can often be frustrating or even perceived as embarrassing by the giver.

Another avenue is looking at wish lists or other lists maintained by the giftee. However, most people are not very active in maintaining these lists. It is often difficult to know whether items on the list are still of interest and the gifter may feel like getting an item directly off a wishlist is a low effort gift that doesn't show much caring on the part of the gifter.

Some gift suggesting programs exist, but these programs almost always depend on the gifter's knowledge of the giftee's interests and possessions; knowledge that the gifter is often lacking.

### SUMMARY

One or more embodiments are provided below for a device, application and method for automated gift suggestion and/or gift giving. The device may include at least one memory including processor readable instructions for controlling the device and at least one processor. The at least one processor may be configured to execute the processor readable instructions to control the device to: obtain user contact information, wherein the user contact information is information relating via a communication method associated with a contact of a user, wherein the user contact information includes information allowing the device to contact the contact of the user; send contact interest request to the contact of the user using the information allowing the device to contact the contact of the user; obtain contact interest information, wherein the contact interest information is a response to the contact interest request; determine suggested gifts for the contact of the user based on the contact interest information; and send a suggested gift list including indications of the suggested gifts to the user.

The device may provide significant advantages over the devices known in the art. For example, the device may provide a service that obtains information directly from the contact (giftee) of the user in order to make suggestions for gifts which greatly increases the likelihood of making useful suggestions. The device may provide reasons why certain gifts are suggested which may help a user feel more at ease about purchasing the gift. The device may also provide a process that allows the user to obtain gifts with minimal effort while providing effective and meaningful gift suggestions and/or the purchase of meaningful gifts.

Other advantageous features as well as other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 shows an example schematic view of a system.

FIG. 2 shows an example flow diagram of steps performed by the second electronic device.

FIG. 3 shows an example data flow diagram of communications between the first electronic device, the second electronic device, and the third electronic device.

FIG. 4 shows an example data flow diagram of communications between the second electronic device and the fourth electronic device.

### DETAILED DESCRIPTION

In the Summary above and in this Detailed Description, the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)−(a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “coupled to” as used herein may mean a direct or indirect connection via one or more components.

Referring now to the drawings and the following written description of the present invention, it will be readily understood by those persons skilled in the art that the present invention is susceptible to broad utility and application. Many embodiments and adaptations of the present invention other than those herein described, as well as many variations, modifications, and equivalent arrangements will be apparent from or reasonably suggested by the present invention and the detailed description thereof, without departing from the substance or scope of the present invention. This disclosure is only illustrative and exemplary of the present invention and is made merely for purposes of providing a full and enabling disclosure of the invention.

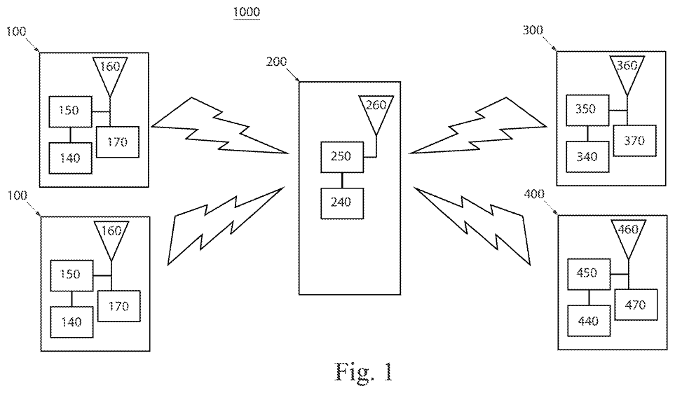

FIG. 1 shows an example schematic view of a system 1000. The system 1000 may include first electronic devices 100, at least one second electronic device 200, at least one third electronic device 300, and at least one fourth electronic device 400. The first electronic devices 100 may be user devices through which users interact with the system 1000. For example, the first electronic devices 100 may include laptop computers, desktop computers, mobile phones, tablets, and other consumer electronic devices. The first electronic device 100 may include a memory 140, a processor 150, and a transceiver 160. The memory 140 may include volatile and non-volatile memory. The memory 140 may contain therein instruction for operating the first electronic device 100 and other stored information. The memory 140 may be a non-transitory processor/computer readable medium holding instructions thereon for implementing the features described below as part of an application, program, or other implementation of electronic instructions using electronic devices. The processor 150 may include one or more processing devices such as a central processing unit, controller, or other similar hardware. The processor 150 may be configured to execute the instructions stored in the memory 140 and control the first electronic device 100. The transceiver 160 may include one or more communication interfaces for wireless communications, wired communications, fiber optic communications, etc. The transceiver 160 may operate based on commands received from the processor 150 and be configured to communicate electronically with other electronic devices in the system 1000. The first electronic device 100 may also include a display 170. The display 170 may be configured to display images and information for a user based on commands received from the processor 150. The display 170 may be a touch screen capable of receiving input from a user. Other inputs such as mice, keyboards, microphones, etc. may also be included in the first electronic device 100.

The second electronic device 200 may be a host device for an application or program. The second electronic device 200 may include one or more computers, servers, or other similar devices. The second electronic device may include a memory 240, a processor 250, and a transceiver 260. The memory 240 may include volatile and non-volatile memory. The memory 240 may contain therein instructions for operating the second electronic device, operating a software platform, and other stored information. The memory 240 may be a non-transitory readable medium holding instructions thereon for implementing the features described below as part of an application, program, or other implementation of electronic instructions using electronic devices. The processor 250 may include one or more processing devices such as a central processing unit, controller, or other similar hardware. The processor 250 may be configured to execute the instructions stored in the memory 240 and control the second electronic device 200. The transceiver 260 may include one or more communication interfaces for wireless communications, wired communications, fiber optic communications, etc. The transceiver 260 may operate based on commands received from the processor 250 and be configured to communicate electronically with other electronic devices in the system 1000. Other inputs such as mice, keyboards, microphones, etc. may also be included in the second electronic device 200.

The third electronic device 300 may be a contact device (e.g., a device associated with a contact of the user). The third electronic device 300 may include at least one laptop computer, desktop computer, mobile phone, tablet, other consumer electronic device, server, and or other electronic device capable of collecting and transmitting information. The third electronic device 300 may include a memory 340, a processor 350, and a transceiver 360. The memory 340 may include volatile and non-volatile memory. The memory 340 may contain therein instruction for operating the third electronic device 300 and other stored information. The memory 340 may be a non-transitory readable medium holding instructions thereon for implementing the features described below as part of an application, program, or other implementation of electronic instructions using electronic devices. The processor 350 may include one or more processing devices such as a central processing unit, controller, or other similar hardware. The processor 350 may be configured to execute the instructions stored in the memory 340 and control the third electronic device 300. The transceiver 360 may include one or more communication interfaces for wireless communications, wired communications, fiber optic communications, etc. The transceiver 360 may operate based on commands received from the processor 350 and be configured to communicate electronically with other electronic devices in the system 1000. The third electronic device 300 may also include a display 370. The display 370 may be configured to display images and information based on commands received from the processor 350. The display 370 may be a touch screen capable of receiving input from a user. Other inputs such as mice, keyboards, microphones, etc. may also be included in the third electronic device 300.

The fourth electronic device 400 may be a shopper device (e.g., a device used to find potential gifts, tag the potential gifts and send updates to the potential list database to the (host) second electronic device). The fourth electronic device 400 may include at least one laptop computer, desktop computer, mobile phone, tablet, other consumer electronic device, server, and or other electronic device capable of collecting and transmitting information. The fourth electronic device 400 may include a memory 440, a processor 450, and a transceiver 460. The memory 440 may include volatile and non-volatile memory. The memory 440 may contain therein instruction for operating the fourth electronic device 400 and other stored information. The memory 440 may be a non-transitory readable medium holding instructions thereon for implementing the features described below as part of an application, program, or other implementation of electronic instructions using electronic devices. The processor 450 may include one or more processing devices such as a central processing unit, controller, or other similar hardware. The processor 450 may be configured to execute the instructions stored in the memory 440 and control the fourth electronic device 400. The transceiver 460 may include one or more communication interfaces for wireless communications, wired communications, fiber optic communications, etc. The transceiver 460 may operate based on commands received from the processor 450 and be configured to communicate electronically with other electronic devices in the system 1000. The fourth electronic device 400 may also include a display 470. The display 470 may be configured to display images and information based on commands received from the processor 450. The display 470 may be a touch screen capable of receiving input from a user. Other inputs such as mice, keyboards, microphones, etc. may also be included in the fourth electronic device 400.

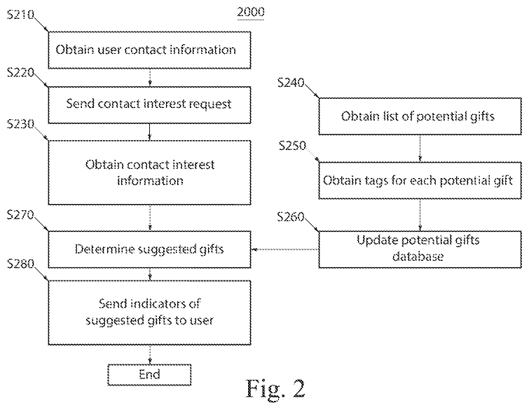

FIG. 2 shows an example flow diagram 2000 of steps performed by the second electronic device 200. All steps in flow diagram 2000 which are performed by the second electronic device 200 may be automated (e.g. performed based on programming and not by user input). At S210, the second electronic device 200 may obtain user contact information from the first electronic device 100 associated with the user. The user contact information may include a method of contacting a contact of the user such as a phone number, an email, or other method of electronic communications. The user contact information may also include event dates (e.g., birthday, anniversary, hiring date, holidays observed etc.) for the contact of the user. The user contact information may also include the relationship between the user and the user contact (e.g., spouse, mother, father, child, co-worker, boss, employee, friend, etc.). The user contact information may also include information about known interest of the user contact, demographic information about the user contact (age, sex, nationality/ethnicity, etc.), and any other information pertaining to the relationship between the user and the user contact or other information relating to the interests of the user. The user contact information may be obtained in response to a questionnaire sent to the first electronic device 100 through a web portal, text message, website, or other form of electronic communication.

At S220, the second electronic device 200 may send a contact interest request to the third electronic device 300 associated with the user contact via the means of electronic communication provided by the user. For example, if a phone number is provided, the second electronic device may send a text message with a link to a website where the user contact can enter the contact interest information. As another example, if an email is provided, an email with questions, or a link to a website with questions may be sent to the user contact's email address. The second electronic device 200 may send the contact interest request when a new user contact is received. The second electronic device 200 may also send the contact interest request after an upcoming gifting event is identified. For example, if the user contact's birthday is within a certain number of days (e.g., 30 days). Questions may include demographic questions, interest and hobby questions, favorite color and other favorite questions, preference questions, etc.

Alternatively, the request for contact interest information may be sent to the first electronic device 100. The user of the first electronic device 100 may answer questions related to the interests of the user contact.

As another example, before the second electronic device 200 sends the request for contact interest information, the second electronic device 200 may send a message to the first electronic device 100 including a link to be forwarded to the third electronic device 300 by an electronic communication method. When the third electronic device 300 receives and opens the link the request for contact interest information may be received and displayed on the third electronic device 300. This method is advantageous because a user contact who may not be a user of the gifting service/application is more likely to respond and answer the questions if they receive the link from their contact than if the link is received directly from a service/application they do use.

At S230, the second electronic device 200 may obtain contact interest information from the third electronic device 300 associated with the user contact and/or the first electronic device 100. The contact interest information may be responses to questions sent to the third electronic device 300 and/or the first electronic device 100. Examples of information received from the first electronic device 100 that may be included in the contact interest information may include gifting event information, interest information, relationship information, demographic information, etc. This information may also be requested from the third electronic device 300 in the contact interest information.

S240-S260 may be performed separately from S210-230, and may be constantly performed. At S240, the second electronic device 200, may obtain a list of potential gifts or other form of indicators of potential gifts from the fourth electronic device 400. The fourth electronic device 400 may be used by a shopper or other person to find potential gifts and generate indicators of the potential gifts to send to the second electronic device 200. The indicators of potential gifts may include an image of the potential gift, a price and a description. The indicators of potential gifts may be compiled into a list and sent to the second electronic device 200.

Alternatively, a program executed by the second electronic device 200 may obtain the indicators of potential gifts by generating the indicators of potential gifts and list of potential gifts.

At S250, the second electronic device 200 may obtain tags for each potential gift and link the tags to the indicators of the potential gifts. The tags may be entered manually by shoppers or other users of the fourth electronic device 400. The tags may indicate interests of a user contact that may match the interest with the potential gift. Examples of tags may be demographic tags, such as “child 3-5,” “teen,” or “women 25-40,” etc., nationality/ethnicity tags, such as “Latino,” “Canadian,” “French,” etc., hobby tags such as, “hiking,” “reading,” “knitting,” etc., and color tags such as, “red,” “blue,” “yellow.” Tags may also be generated based on occasion. For example, some potential gifts may be tagged as “anniversary,” “birthday,” or “wedding.” Some potential gifts may be tagged with more specific tags for events such as “5th anniversary,” or “40th birthday.”

Alternatively or in addition, a program executed by the second electronic device 200 may obtain the tags by analyzing the image of the potential gift and the description of the potential gift and generating tags based on the analysis. Other information such as marketing and sales information may also be used.

At S260, the second electronic device may update a database for potential gifts stored in the memory 240. The potential gifts database may include indicators of the potential gifts (including image(s) and description), tags associated with the potential gifts, inventory information, links to sellers for the potential gifts, and other information for presenting the potential gifts to users for purchase.

At S270, the second electronic device 200 may determine suggested gifts for the user to give to the user contact based on the user contact information and the tags for the potential gifts in the potential gifts database. For example, demographic information of the user contact may be matched with demographic tags on potential gifts, hobby information of the user contact may be matched with hobby tags on potential gifts, and favorite color information of the user contact may be matched with color tags on the potential gifts in the potential gift database. The second electronic device 200 may organize the list of potential gifts using any number of criteria including market data showing which items are best sellers, number of matching tags, gift type, price, availability, etc.

The second electronic device 200 may also generate reasons why each potential gift was determined to be a suggested gift. For example, if the potential gift was selected as a suggested gift because the demographic data of the user contact and the demographic tag of the gift and the hobby data of the user contact matched the hobby tag of the potential gift a reason such as the following may be generated: “This item is popular among men ages 25-40 who like to hike.” As another example, if the potential gift was selected as a suggested gift because the gifting event of the user contact and the occasion tag of the potential gift and the ethnicity/nationality data of the user contact matched the ethnicity/nationality tag of the potential gift a reason such as the following may be generated: “This item is traditionally given as a 25th anniversary gift in Finland.”

At S280, the second electronic device may send indicators of suggested gifts to the first electronic device 100 associated with the user. The indicators of suggested gifts may be sent in an email, text message, or other electronic communication. Further, a link may be sent to an email or phone number of the user and the user may then open the link in a web portal, application, etc. and the indicators of suggested gifts may be displayed in the web portal, application, etc. The indicators of the suggested gifts may include the images and description of the potential gifts. Reasons for suggesting the gifts may also be sent to the user together with the indicators of suggested gifts. The indicators of suggested gifts may be sent in a list, as links to seller's websites, or in another form.

The process may end after S280 or as will be discussed below, the second electronic device 200 may be configured to allow the users via the first electronic device 100 to purchase the suggested gifts.

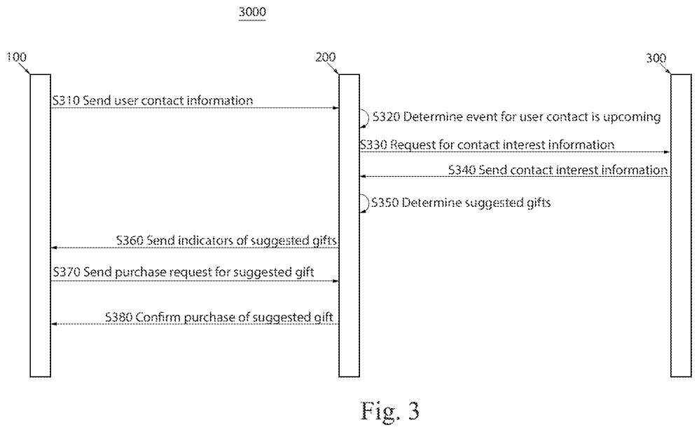

FIG. 3 shows an example data flow diagram 3000 of communications between the first electronic device 100, the second electronic device 200 and the third electronic device 300. At S310 the first electronic device may send user contact information to the second electronic device 200. The first electronic device 100 and the second electronic device 200 may communicate via email, text message, internet portal, mobile application, web browser, or other electronic methods. The user contact information may include information regarding gifting events, such as birthdays, anniversary, holiday observance, etc. for contacts of the user (i.e., user contacts). The user contact information may also include the relationship between the user and the user contacts and a method of communication with each user contact.

At S320, the second electronic device 200 may determine a gifting event for a user contact is upcoming. A user event may be determined as being upcoming if it is within a certain amount of time from the current date, such as 30 days.

At S330, the second electronic device 200 may send a request for contact interest information to a third electronic device 300 associated with the user contact (or a parent/caretaker of the user contact if the user contact is a child or other person who may need assistance using an electronic device). Before the second electronic device 200 sends the request for contact interest information, the second electronic device 200 may send a message to the first electronic device 100 including a link to be forwarded to the third electronic device 300 by an electronic communication method. When the third electronic device 300 receives and opens the link the request for contact interest information may be received and displayed on the third electronic device 300. Alternatively, the second electronic device 200 may send the link directly to the third electronic device 300 associated with the user contact if it is authorized by the user of the first electronic device 100. The contact methods of each user contact does not have to be unique. For example, the same email may be used as a contact method for user contacts including the user's sister and nieces and nephews. The second electronic device 200 and the third electronic device 300 may communicate via email, text message, internet portal, mobile application, web browser, or other electronic methods. An email or text message with a link to an application or internet page in which the user contact may receive the request for user contact information (in the form of questions to be answered on the web page or in the application) and respond to the request for contact interest information. The request for contact interest information may include various questions for the user contact to answer regarding, demographics, interests, hobbies, favorite color, ethnicity/nationality, etc.

At S340, the third electronic device 300 may send and the second electronic device 200 may receive/obtain the contact interest information from the user contact. The contact interest information may be answers to questions in the request for contact interest information.

As S350, the second electronic device 200 may determine the suggested gifts from the database of potential gifts by matching tags on the potential gifts with the contact interest information of the user contact. The type of gifting event and the relationship between the user and the user contact may also affect suggested gifts. For example, a suggested gift for a husband to give to his wife on an anniversary may be different from a suggested gift for a wife to give her husband on the same anniversary. Further, a suggested gift for a child to give his/her parents for the same anniversary may be different. Tags for each of these relationships and other relationships may be attached to potential gifts in the database of potential gifts in the memory 240 of the second electronic device 200.

The selection of the suggested gifts may be based on the relationship between the user and the user contact, the gifting event, price range, marketing data, demographic information, and other information included in or extrapolated from the contact interest information.

At S360, the second electronic device may send and the first electronic device 100 associated with the user may receive indicators of suggested gifts. The indicators of the suggested gifts may include images and description of the suggested gifts. The second electronic device may send and the first electronic device 100 associated with the user may receive reasons for each suggested gift being suggested. The indicators of suggested gifts may also include purchase information including links to or options to purchase the suggested gift.

At S370, the first electronic device 100 may send and the second electronic device 200 may receive a purchase request for a suggested gift. The purchase request may include payment information, shipping information, and other information necessary for completing the purchase. The second electronic device 200 may process the purchase request and/or may communicate with other electronic devices (such as bank devices) to fully process the purchase request.

At S380, if the purchase request is approved the second electronic device 200 may send and the first electronic device 100 may receive confirmation of purchase of the suggested gift. The confirmation may include shipping details, charges made to an account, and other applicable information. The second electronic device 200 may communicate with other devices such as seller devices, shipper devices, etc. to schedule the delivery of the purchased suggested gift.

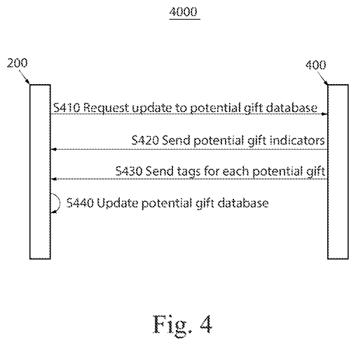

FIG. 4 shows an example data flow diagram 4000 of communications between the second electronic device 200 and the fourth electronic device 400. At S410, the second electronic device 200 may send and the fourth electronic device 400 may receive a request to update the potential gift database. This step may be optional because the fourth electronic device 400 may already be programmed to automatically send updates or the users of the fourth electronic device 400 may be previously instructed to provide updates. The fourth electronic device 400 may be associated with shoppers or other people tasked with finding and processing potential gifts. Alternatively, the fourth electronic device 400 may be programmed to find and process potential gifts in an automated manner. The second electronic device 200 and the fourth electronic device 400 may communicate via email, text message, internet portal, mobile application, web browser, or other electronic methods.

At S420, the fourth electronic device 400 may send and the second electronic device 200 may receive potential gift indicators. The potential gift indicators may include images and description of the potential gifts. The images and descriptions of the potential gifts may be obtained from manufacturers, retailers, or sellers of the potential gifts. Further, the images and description of the potential gifts may be generated by persons using the fourth electronic device 400, or the fourth electronic device 400 itself.

At S430, the fourth electronic device may send and the second electronic device 200 may receive tags for each potential gift. The tags may include tags for demographic that may be interested in the potential gift, gifting events that the potential gift may be relevant to, hobbies or interests that the potential gift may relate to, colors of the potential gift, price range of the potential gift, relationship of the gift giver to the giftee, relevant culture or ethnicity to the potential gift, as well as any other information relevant to selecting a gift for a person. The tags may be generated by persons using the fourth electronic device 400, and/or the fourth electronic device 400 itself operating in an automated manner. For example, if a potential gift includes a description that states that the potential gift says “happy birthday” the fourth electronic device 400 may in an automated manner determine to tag the potential gift as relating to birthdays. A person may confirm any automated tags. A person may also tag the potential gift with additional tags after the automated tags are generated.

At 440, the second electronic device 200 may update the potential gift database stored in the memory 240 with the received potential gift indicators and tags for the potential gifts. The updated potential gift database may be used for suggesting gifts for user contacts.

Many different embodiments of the inventive concepts have been shown. A person of ordinary skill in the art will appreciate that the features from different embodiments may be combined or replaced with other features from different embodiments.

In one embodiment a device (e.g., the second electronic device 200) may include at least one memory (e.g., memory 240) including processor readable instructions for controlling the device and at least one processor (e.g., processor 250). The at least one processor may be configured to execute the processor readable instructions to control the device to: obtain user contact information, wherein the user contact information is information relating via a communication method associated with a contact of a user, wherein the user contact information includes information allowing the device to contact the contact of the user; send contact interest request to the contact of the user using the information allowing the device to contact the contact of the user; obtain contact interest information, wherein the contact interest information is a response to the contact interest request; determine suggested gifts for the contact of the user based on the contact interest information; and send a suggested gift list including indications of the suggested gifts to the user.

The determining the suggested gifts for the contact of the user may be further based on matching the tags for indicators for potential gifts to the contact interest information. The suggested gift list may include listed reasons why the indications of the suggested gifts are included in the suggested gift list. The reasons why the indications of the suggested gifts may be included in the suggested gift list and are determined based on the matching of the tags for indicators for potential gifts to the contact interest information. The processor may be configured to execute the processor readable instructions to control the device to: receive indicators of upcoming events. The contact interest request may be sent in response to the indicators of the upcoming event.

Advantageously, the device may provide a service that obtains information directly from the user contact (via the third electronic device 300) of the user in order to make suggestions for gifts. Which greatly increases the likelihood of making useful suggestions. The device may provide reasons why certain gifts are suggested which may help a user feel more at ease about purchasing the gift. The device may also provide a process that allows the user to obtain gifts with minimal effort while providing effective and meaningful gift suggestions and/or the purchase of meaningful gifts.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A device comprising:
at least one memory including processor readable instructions for controlling the device; and
at least one processor configured to execute the processor readable instructions to control the device to:
obtain user contact information, wherein the user contact information is information relating via a communication method associated with a contact of a user, wherein the user contact information includes information allowing the device to contact the contact of the user;
send contact interest request to the contact of the user using the information allowing the device to contact the contact of the user;
obtain contact interest information, wherein the contact interest information is a response to the contact interest request;
determine suggested gifts for the contact of the user based on the contact interest information; and
send a suggested gift list including indications of the suggested gifts to the user.

2. The device of claim 1, wherein the processor configured to execute the processor readable instructions to control the device to:
obtain tags for indicators for potential gifts in a potential gift database, wherein the tags relate to an attribute of interest, wherein the determining the suggested gifts for the contract of the user is further based on the tags for indicators for potential gifts.

3. The device of claim 2, wherein the determining the suggested gifts for the contact of the user is further based on matching the tags for indicators for the potential gifts to the contact interest information.

4. The device of claim 3, wherein the suggested gift list includes listed reasons why the indications of the suggested gifts are included in the suggested gift list.

5. The device of claim 4, wherein the reasons why the indications of the suggested gifts are included in the suggested gift list and are determined based on the matching of the tags for indicators for potential gifts to the contact interest information.

6. The device of claim 1, wherein the processor configured to execute the processor readable instructions to control the device to:
receive indicators of upcoming events, wherein
the contact interest request is sent in response to the indicators of the upcoming event.

7. A non-transitory processor readable medium including instructions which when executed by a processor cause the processor to:
obtain user contact information, wherein the user contact information is information relating via a communication method associated with a contact of a user, wherein the user contact information includes information allowing the device to contact the contact of the user;
send contact interest request to the contact of the user using the information allowing the device to contact the contact of the user;
obtain contact interest information, wherein the contact interest information is a response to the contact interest request;
determine suggested gifts for the contact of the user based on the contact interest information; and
send a suggested gift list including indications of the suggested gifts to the user.

8. The device of claim 7, wherein the processor readable instruction when executed by the processor cause the processor to:
obtain tags for indicators for potential gifts in a potential gift database, wherein the tags relate to an attribute of interest, wherein
the determining the suggested gifts for the contract of the user is further based on the tags for indicators for potential gifts.

9. The device of claim 8, wherein the determining the suggested gifts for the contact of the user is further based on matching the tags for indicators for potential gifts to the contact interest information.

10. The device of claim 9, wherein the suggested gift list includes listed reasons why the indications of the suggested gifts are included in the suggested gift list.

11. The device of claim 10, wherein the reasons why the indications of the suggested gifts are included in the suggested gift list and are determined based on the matching of the tags for indicators for potential gifts to the contact interest information.

12. The device of claim 7, wherein the processor readable instruction when executed by the processor cause the processor to:
receive indicators of upcoming events, wherein
the contact interest request is sent in response to the indicators of the upcoming event.

13. A method comprising:
obtaining, by an electronic device, user contact information, wherein the user contact information is information relating via a communication method associated with a contact of a user, wherein the user contact information includes information allowing the device to contact the contact of the user;
sending, by the electronic device, contact interest request to the contact of the user using the information allowing the device to contact the contact of the user;
obtaining, by the electronic device, contact interest information, wherein the contact interest information is a response to the contact interest request;
determining, by the electronic device, suggested gifts for the contact of the user based on the contact interest information; and
sending, by the electronic device, a suggested gift list including indications of the suggested gifts to the user.

14. The method of claim 13, wherein the processor configured to execute the processor readable instructions to control the device to:
obtaining, by the electronic device, tags for indicators for potential gifts in a potential gift database, wherein the tags relate to an attribute of interest, wherein
the determining the suggested gifts for the contract of the user is further based on the tags for indicators for potential gifts.

15. The method of claim 14, wherein the determining the suggested gifts for the contact of the user is further based on matching the tags for indicators for potential gifts to the contact interest information.

16. The method of claim 15, wherein the suggested gift list includes listed reasons why the indications of the suggested gifts are included in the suggested gift list.

17. The method of claim 16, wherein the reasons why the indications of the suggested gifts are included in the suggested gift list and are determined based on the matching of the tags for indicators for potential gifts to the contact interest information.

18. The method of claim 13, wherein the processor configured to execute the processor readable instructions to control the device to:
receiving, by the electronic device, indicators of upcoming events, wherein
the contact interest request is sent in response to the indicators of the upcoming event.
